(19) United States
(12) Patent Application Publication
(10) Pub. No.: US 2007/0082703 A1
(43) Pub. Date: Apr. 12, 2007

(54) Method and system for providing wireless identification

(75) Inventor: Radboud Joseph Julius Chrysostomos Van Kleef, Voorburg (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Koninklijke KPN N.V.

(21) Appl. No.: 10/576,549

(22) PCT Filed: Oct. 28, 2004
(86) PCT No.: PCT/EP04/12249

§ 371 Date: Apr. 20, 2006

(51) Int. Cl. H04B 1/38

(52) U.S. Cl. 455/558

(57) ABSTRACT

A mobile communication device (1) containing a SIM card (2) with a SIM chip (3) is enhanced with a RF-ID tag (4). Providing the possibility to combine the secure identification means of the RF-ID tag with the communication functions of the mobile device with the SIM chip, without the need for the user to obtain a new device.

### FIELD OF THE INVENTION

The present invention is related to wireless communication networks. More specifically, a method and system for using a wireless communication device for identification purposes is disclosed.

### BACKGROUND OF THE INVENTION

Nowadays the use of wireless communication devices like for example mobile phones or personal digital assistants (PDA) is widespread. With the emergence of new technologies the use of these devices is not limited to voice applications. A lot of new data communication applications are being developed, for instance based on a third generation telecommunication protocol, e.g. UMTS. It is generally accepted that in the near future mobile devices will be used for applications like buying tickets and making small payments. So far a majority of those areas have required that persons bring along a physical ticket—a special piece of paper or plastic card that is the token enabling the access to specific areas or identifying a bearer as someone accredited for specific actions/benefits. Since most people are carrying a mobile communication device, it is a great opportunity to provide virtual tickets or tokens on a mobile device. In this way the user has the possibility to store e.g. payment means, tickets and tokens from several service providers in his ever present mobile device. A major issue in the development of these systems is the secure identification of a user. On the other hand, RF-ID (Radio Frequency Identification) tags have started to gain a large popularity and are more and more being employed. A RF-ID tag consists of a miniscule microchip connected to an antenna, usually printed on a thin sheet of plastic. RF-ID tags provide secure means of identifying goods and persons carrying the tags. A RF-ID tag can also represent a value, like a ticket providing access to an area or venue. However, with RF-ID technology the problem inherent to traditional ticketing remains: one ticket/tag is required for one purpose. Also the ticket is tied to a physical medium of the card and cannot be delivered wirelessly over large distances. Combining the secure identification means of RF-ID tags with the communication means of mobile devices could present a solution to the identification requirements of mobile commerce applications.

WO 02/49322 discloses a mobile telephone (10) including a device for checking the identity of a user in connection with various transactions. The device may include one or more of fingerprint scanning means, voice or password recognition means (e.g. using a microphone of the telephone), photograph display means (e.g. using a display of the telephone) or retina recognition means. The telephone also includes a short-range communication means for undertaking RFID smart card transactions. A user can load data representing money by means of a telephone communication into a memory for use is subsequent transactions. Alternatively, current transactions may be validated. The memory may have sub-divisions corresponding to different smart cards.

A drawback of this system is that the mobile phone itself needs to be adapted. All existing phones are not suitable to be used with the disclosed system.

Problem Definition

Thus the prior art fails to disclose an easy to implement system and method for using the identification means of a RF-ID tag in a wireless communication device.

Aim of the Invention

The aim of the invention is to provide an easy to implement system and method for using the identification means of a RF-ID tag in a wireless communication device.

### SUMMARY OF THE INVENTION

According to a first aspect of the invention a method for enhancing a wireless communication device, containing a SIM chip on a SIM card, with secure identification means, comprising adding a RF-ID tag to said wireless communication device, is disclosed. The RF-ID tag may be used to identify a person or alternatively a value like e.g., but not limited to, a ticket providing the user of the wireless device access to a venue.

Preferably the RF-ID tag and the SIM chip can exchange information. This information may concern the ID of the SIM chip and the RF-ID tag, but may also relate to information send to the memory part of the SIM chip in the form of e.g. a SMS message.

Preferably the RF-ID tag is located on the SIM card. One of the advantages is that all existing mobile devices are capable of using the RF-ID enhanced SIM card according to the invention. The user does not need to obtain a new device.

According to a second aspect of the invention a SIM card with a SIM chip comprising a RF-ID tag is disclosed.

### BRIEF DESCRIPTION OF THE DRAWINGS

The invention will be further explained by reference to examplary embodiments shown in the drawings in which:

FIG. 1 shows an example of a RF-ID tag enhanced SIM card;

FIG. 2 shows an example of how a RF-ID tag enhanced SIM card can communicate with the SIM card;

FIG. 3 shows an example of how a wireless device comprising a RF-ID tag enhanced SIM card can be used to communicate with a RF-ID tag reader of a service provider.

### DETAILED DESCRIPTION OF THE INVENTION

For the purpose of teaching of the invention, preferred embodiments of the method and system of the invention are described in the sequel. It will be apparent to the person skilled in the art that other alternative and equivalent embodiments of the invention can be conceived and reduced to practice without departing from the true spirit of the invention, the scope of the invention being only limited by the claims as finally granted.

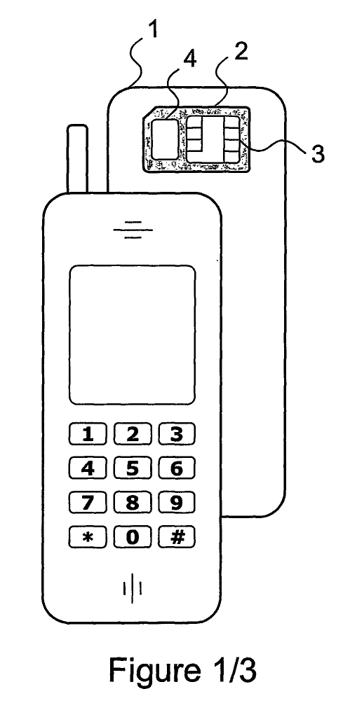

FIG. 1 shows a mobile phone (1) comprising a RF-ID tag enhanced SIM card (2). A RF-ID tag (4) is added to the traditional SIM card, already comprising the SIM chip (3) that is needed to operate the mobile phone. With a RF-ID tag enhanced SIM card it is not necessary to adjust a wireless device, to provide the use of RF-ID technology. The owner of a wireless device only has to change his SIM card, something he can do quite easily.

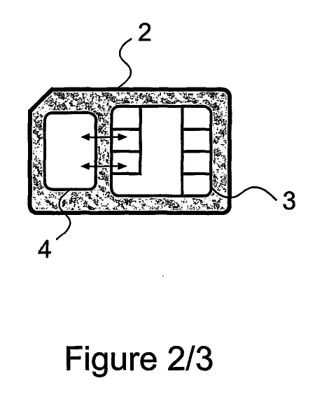

FIG. 2 shows how the RF-ID tag (4) on a SIM card (2) can communicate with the SIM chip (3). The RF-ID tag can both read and write information on the SIM chip and vice versa. The RF-ID tag can communicate with the manufacturers area on the SIM chip, providing the possibility to use, in addition to its own ID, the SIM identity means, the KI and IMSI, for identification purposes. The RF-ID tag can also access the memory portion of the SIM chip and read the information that was delivered to the SIM chip of the mobile device for example by SMS (short message service). In this way it is possible to receive new data for the RF-ID tag over the wireless communication network. That means that ID codes (e.g. virtual tickets) can be delivered to the RF-ID tag enhanced SIM card through existing OTA (over the air) mechanisms, and the mobile device itself can be used as a carrier for all virtual tickets and loyalty cards.

With a system according to the invention, it will be possible to offer applications like but not limited to:
Mobile-Ticketing: access to concerts, cinemas, sport centres, ski-areas and other various venues
Access control: temporary or permanent validity codes can be sent to visitors which grants them access for a certain period to business buildings. Access rights can be regulated via OTA SMS—very flexible for buildings with a large number of visitors or fast fluctuating workforce (virtual access card).
Mobile-Loyalty cards/virtual membership cards: a permanent code can be sent to persons holding a specific membership information like an Airmiles number or membership information for video rental store.
Micro payments: pre-paid: RF-ID tag can act as a wireless prepaid chipcard. Putting extra money on the card can be done wirelessly. Existing prepaid chipcard payment terminals could be refitted for wireless.
Post-paid payments: IMSI/KI/own ID could be used for post paid invoicing.

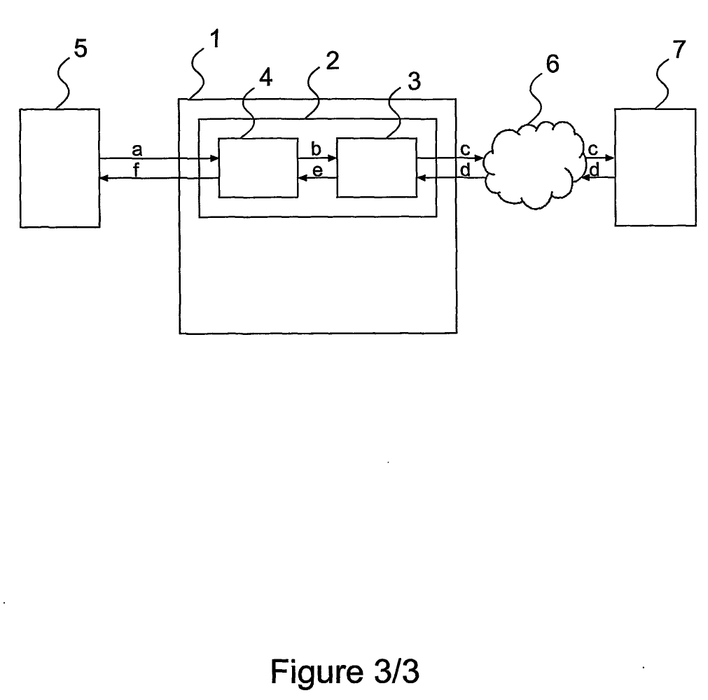

FIG. 3 shows an example of how a wireless device (1) comprising a RF-ID tag enhanced SIM card (2) can be used for providing a mobile/virtual ticket, using a reader/transciever of a service provider (5). In this example the Transceiver/Tagreader (5) is placed at the entrance of a movie theater (for this example: the service provider). When the owner of mobile phone (1) approaches the transceiver, the RF-ID tag (4) is activated by a radio query transmitted by the transceiver (5) and receives the identity of the transceiver (step a). The RF-ID tag communicates its own ID and the ID of the transciever to the SIM chip (step b). The user can use this information to communicate with the service provider (7) e.g. via the Internet (6), using the mobile device (1), or e.g. by sending a SMS to the service provider using the mobile device (1), (step c). After checking the identity of the user and handling necessary payment steps, the service provider can send back a ticket (step d) e.g. by means of a SMS to the mobile device. This ticket can be stored in the SIM chip. The RF-ID tag can read this information (step e) and subsequently send the relevant information to the transciever of the service provider (f), thus enabling the user of the mobile phone to access the movie theater.

1. Method for enhancing a wireless communication device (1), containing a SIM chip (3) on a SIM card (2), with secure identification means, comprising adding a RF-ID tag (4) to said wireless communication device.

2. Method according to claim 1, wherein said RF-ID tag (4) and said SIM chip (3) can exchange information.

3. Method according to claim 1 or 2, wherein said RF-ID tag (4) is located on said SIM card (2).

4. SIM card with a SIM chip comprising a RF-ID tag.
